(19) United States
(12) Patent Application Publication
(10) Pub. No.: US 2026/0029229 A1
(43) Pub. Date: Jan. 29, 2026

(54) MEASUREMENT DEVICE

(71) Applicant: FANUC CORPORATION, Yamanashi (JP)

(72) Inventors: Takuma OOKURA, Yamanashi (JP); Tooru KUBOTA, Yamanashi (JP); Yasusuke IWASHITA, Yamanashi (JP)

(21) Appl. No.: 18/995,836

(22) PCT Filed: Sep. 28, 2022
(86) PCT No.: PCT/JP2022/036109

§ 371 Date: Jan. 17, 2025

(51) Int. Cl. G01B 11/24; G01B 11/00; G01B 17/06; H02P 6/06

(52) U.S. Cl. CPC G01B 11/2416; G01B 11/005; G01B 17/06; H02P 6/06

(57) ABSTRACT

A measurement device includes: a calculation unit calculating, based on a signal inputted from a measurement instrument, a coordinate value of a position at which the shape of a measurement surface of an object under measurement changes; a recording unit recording measurement information concerning the time interval at which the shape of the measurement surface of the object under measurement changes; and a determining unit determining, if the time interval at which the shape of the measurement surface of the object under measurement changes as recorded by the recording unit is shorter than a prescribed first threshold defined in advance, that the relative speed between the measurement surface of the object under measurement and the measurement instrument is improper. Upon determining that the relative speed is improper, the measurement device communicates that the evaluation of the measurement surface of the object under measurement is not being correctly carried out.

### RELATED APPLICATIONS

The present application is a National Phase of International Application No. PCT/JP2022/036109 filed Sep. 28, 2022.

### TECHNICAL FIELD

This disclosure relates generally to a measurement device.

### BACKGROUND ART

There is a technology to evaluate a geometry by analyzing a signal input from a measuring instrument and calculating coordinate values of the signal at its rising edge and falling edge (e.g. Patent Literature 1). Such a technology is used, for example, when machining is carried out on the geometry of a workpiece that has an uneven surface, such as a gear, to evaluate the geometry of a gear tooth by detecting the rise and fall of the gear tooth.

### PRIOR ART DOCUMENT

### Patent Literature

[Patent Literature 1] Japanese Patent Laid-Open Publication No. 2020-055072

### BRIEF DESCRIPTION OF THE DRAWINGS

FIG. 1 is a schematic hardware configuration diagram of a measurement device according to a first embodiment of the present disclosure;

FIG. 2 is a schematic diagram showing geometric measurement on a gear using the measurement device according to the first embodiment;

FIG. 3 is a block diagram showing schematic functions of the measurement device according to the first embodiment of the present disclosure;

FIG. 4 is a graph showing an example of a series of distance data calculated based on a signal input from a measuring instrument;

FIG. 5 is a graph showing another example of the series of the distance data calculated based on the signal input from the measuring instrument;

FIG. 6 is a block diagram showing schematic functions of a measurement device according to a second embodiment of the present disclosure; and

FIG. 7 is a schematic diagram of geometry measurement on a surface of a workpiece using the measurement device according to the second embodiment.

### DETAILED DESCRIPTION OF THE INVENTION

According to the disclosure, when measuring a geometry of a measurement object, a relative rate between a measuring surface of the measurement object and the measuring instrument is increased to shorten a cycle time for estimating the geometry of the measuring surface of the measurement object. For example, in a case of estimating the geometry of a tooth of a gear, a rotational speed of the gear is increased during measuring the unevenness of the gear tooth by the measuring instrument so as to shorten the cycle time for estimating the geometry of the gear. However, the measurement device needs a predetermined processing time to analyze a signal from the measuring instrument and calculate coordinate values of a rise position and a fall position of the tooth. Thus, in a case where the rise and the fall occur consecutively within the processing time for coordinate value calculation, the calculation of each coordinate value may not be performed accurately.

It is therefore desired that a determination can be made about whether the relative rate between the measuring surface of the measurement object and the measuring instrument is controlled according to the processing ability of the measurement device.

A measurement device according to the present disclosure determines whether the relative rate between the measuring surface of the measurement object and the measuring instrument is appropriate based on the processing ability of the measurement device and measurement information. The signal input from the measuring instrument is monitored and a determination is made about whether or not the coordinate values of the position where the geometry of a workpiece changes at the present speed can be calculated properly, thereby solving the above-described problem.

One aspect of the present disclosure is a measurement device that includes: a coordinate value calculation unit that moves a relative position with respect to a measuring surface of a measurement object, and calculates coordinate values of a position at which a geometry of the measuring surface is changed based on a signal input from a measuring instrument for measuring a geometry change in the measuring surface; a measurement information recording unit that records measurement information about a time interval during which the geometry change occurs in the measuring surface of the measurement object; and a speed improperness determination unit that determines that a relative speed between the measuring surface of the measurement object and the measuring instrument is improper when the time interval recorded by the measurement information recording unit, during which the geometry change occurs in the measuring surface of the measurement object, is shorter than a predefined given first threshold, wherein when it is determined that the relative speed between the measuring surface of the measurement object and the measuring instrument is improper, the speed improperness determination unit makes a notification that the measuring surface of the measurement object is not evaluated correctly.

### First Embodiment

A description will now be made about an embodiment of the present disclosure by referring to the accompanying drawings.

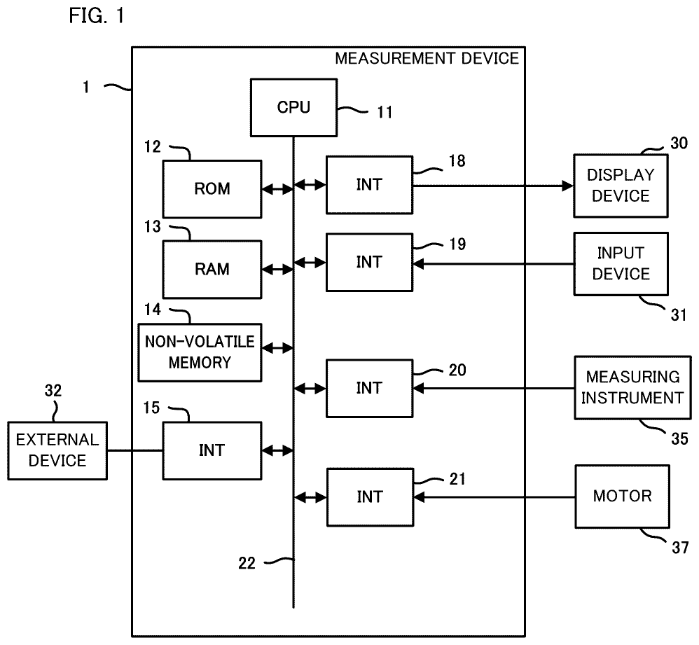

FIG. 1 is a schematic hardware configuration diagram showing a main part of a measurement device according to a first embodiment of the present disclosure. The illustrative embodiment describes an example of a measurement device 1 that measures rise and fall positions of a gear tooth as a measurement object.

The measurement device 1 according to the first embodiment includes a central processing unit (CPU) 11 that is a processor for controlling the entire measurement device 1. The CPU 11 reads a system program stored in a read-only memory (ROM) 12 via a bus 22 to control the entire measurement device 1 according to the system program. A random-access memory (RAM) 13 is configured to temporarily store temporary computation data and pieces of data to be displayed, as well as various data input from outside.

A non-volatile memory 14 consists of, for example, a memory backed up by a battery not shown, or solid state drive (SSD), so that storage conditions can be retained even when a power source of the measurement device 1 is turned off. The non-volatile memory 14 is configured to store, for instance, programs and pieces of data read from an external device 32 via an interface 15, programs and pieces of data input through an input device 31, and data computed based on a signal input from a measuring instrument 35. The programs and the various data stored in the non-volatile memory 14 may be loaded into the RAM 13 when they are executed/used. Furthermore, the ROM 12 stores in advance various system programs, such as known analysis programs.

The interface 15 is configured to connect the CPU 11 of the measurement device 1 to the external device 32, such as a USB. From the external device 32, control programs, parameters and others used for controlling an industrial machine 3 can be read out, by way of example. In addition to that, control programs, parameters and others edited in the measurement device 1 can be stored in external storing means via the external device 32.

A display device 30 is configured to display pieces of data, which are acquired as a result of executing the various data, the programs and system programs read into a memory and output through an interface 18. Furthermore, the input device 31 consists of a keyboard, a pointing device and the like and is configured to transfer commands, pieces of data and others according to operations made by an operator to the CPU 11 via an interface 19.

The measuring instrument 35 is connected to the measurement device 1 via an interface 20. The measuring instrument 35 may be, for instance, a distance detector that emits a laser beam to detect a distance based on the reflection of the emitted beam. Alternatively, the measuring instrument 35 may be an ultrasound sensor. The interface 20 converts a signal input from the measuring instrument 35 into distance data to transfer the obtained data to the CPU 11.

A motor 37 is connected to the measurement device 1 via an interface 21. The interface 21 drives the motor 37 based on a control command for the motor 37 input from the CPU 11. The motor 37 has a built-in position/speed detector, so as to feed back a position/speed feedback signal obtained from the position/speed detector. On the basis of the control command and the feedback signal, the position and the speed of the motor 37 are controlled.

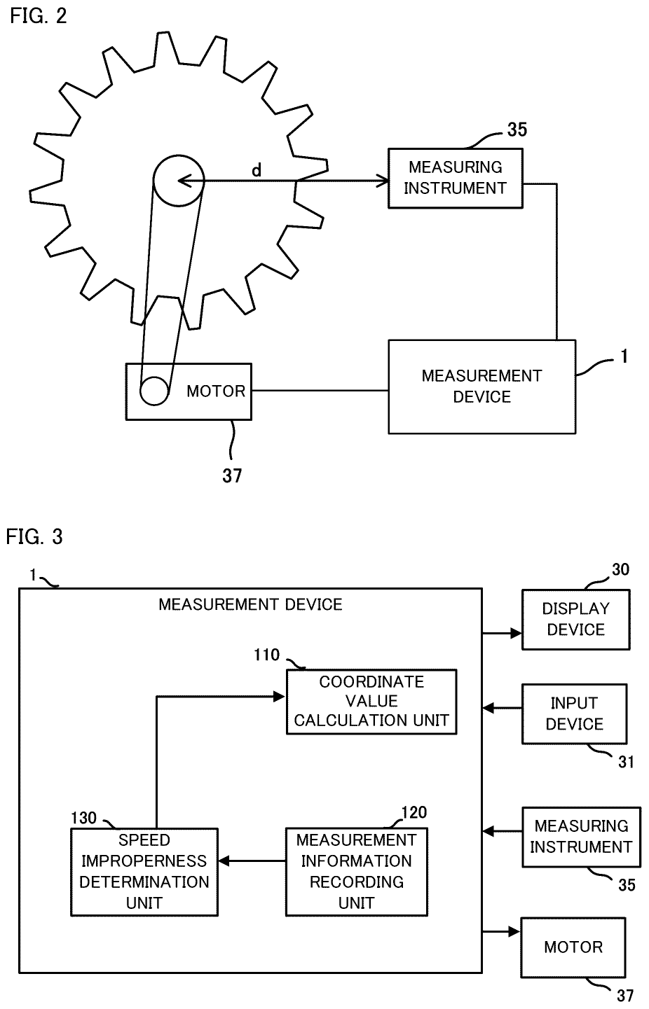

FIG. 2 is a schematic diagram of geometry measurement on a gear by using the measurement device 1 according to the illustrative embodiment. The measurement device 1 is connected to the measuring instrument 35 and the motor 37. The gear to be measured is attached to a predetermined rotation axis. The rotation axis is rotated by power transmission from the motor 37 via a power transmission member, such as a pulley or rotating belt. The measuring instrument 35 is arranged at a location away from the rotation center of the gear in a circumferential direction by a predetermined distance d toward the rotation center of the gear.

By arranging the measuring instrument at the above-described location, the motor 37 is driven to rotate the gear, and an analysis is made on the signal from the measuring instrument 35 so that a measurement is carried out on a distance from the measuring instrument 35 to a gear tooth tip when the gear tooth tip is in the measuring position or a distance from the measuring instrument 35 to a gear tooth root when the gear tooth root is in the measuring position, by way of example. The measuring instrument 35 outputs a signal indicating the measured distance to the measurement device 1. The measurement device 1 can calculate the distance from the rotation center of the gear to the measuring position by, for example, subtracting the distance measured by the measuring instrument 35 from the distance d between the measuring instrument 35 and the rotation center of the gear.

FIG. 3 shows functions of the measurement device 1 according to the illustrative embodiment in a schematic block diagram. The functions of the measurement device 1 of the illustrative embodiment are implemented in such a way that the CPU 11 included in the measurement device 1 shown in FIG. 1 executes a system program so as to control the operations of the components of the measurement device 1.

The measurement device 1 of the illustrative embodiment includes a coordinate value calculation unit 110, a measurement information recording unit 120, and a speed improperness determination unit 130.

The coordinate value calculation unit 110 is configured to calculate coordinate values of a rise position and a fall position of a gear tooth based on a signal input from the measuring instrument 35. The coordinate value calculation unit 110 stores a series of distance data calculated based on the signal input from the measuring instrument 35, for instance, in a predetermined buffer memory prepared beforehand. In a case where a predetermined number or more of series of distance data, which indicate distances shorter than previously measured distances, are obtained continuously, the coordinates of the rise position of the tooth may be calculated from these series of distance data. In a case where a predetermined number or more of series of distance data, which indicate distances longer than the previously measured distances, are obtained continuously, the coordinates of the fall position of the tooth may be calculated from these series of distance data. The coordinate value calculation unit 110 displays the calculated coordinate values on the display device 30.

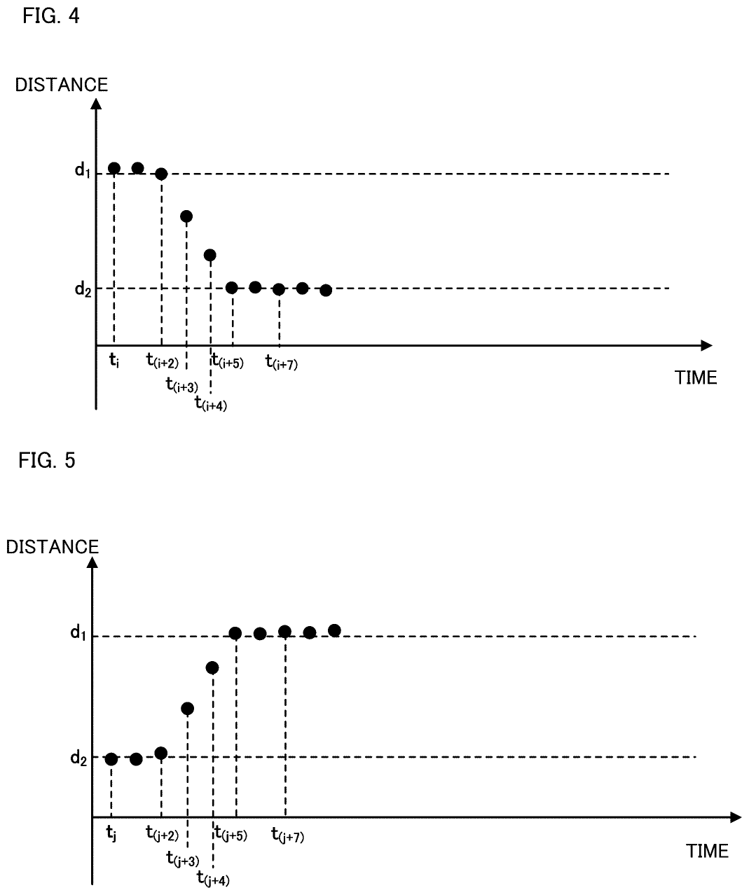

FIG. 4 is a graph showing an example of the series of distance data calculated based on the signal input from the measuring instrument 35. To the measurement device 1, a signal is input from the measuring instrument 35 at each predetermined cycle. The distance data calculated based on the input signal is stored in the buffer memory. The buffer memory stores a predetermined number of the latest distance data. In this case, the coordinate value calculation unit 110 monitors the series of distance data to be stored in the buffer memory. After series of distance data indicating a predetermined distance d₁ are continued (times tᵢ to t₍ᵢ₊₂₎ in FIG. 4), the distance changes significantly (times t₍ᵢ₊₃₎ to t₍ᵢ₊₄₎ in FIG. 4), followed by series of distance data indicating a distance d₂ which is shorter than the predetermined distance d₁ (times t₍ᵢ₊₅₎ to t₍ᵢ₊₇₎). When such a trend of change in the distance is detected, the coordinate value calculation unit 110 calculates the coordinate values of the rise position of the gear tooth based on the position of the motor 37 at any time between the time when the distance d₁ was detected last time and the time the distance d₂ was detected for the first time. The coordinate values of the rise position can be calculated appropriately based on the position of the motor 37 at the concerned time and a speed reduction ratio of the power transmission member.

FIG. 5 is a graph showing another example of the series of distance data calculated based on the signal input from the measuring instrument 35. The coordinate value calculation unit 110 monitors the series of distance data to be stored in the buffer memory, in which after series of distance data indicating the predetermined distance d₂ are continued (times tⱼ to t₍ⱼ₊₂₎ in FIG. 5), the distance changes significantly (times t₍ⱼ₊₃₎ to t₍ⱼ₊₄₎ in FIG. 5), followed by series of distance data indicating a longer distance d₁ than the predetermined distance d₂ (times t₍ⱼ₊₅₎ to t_{(j+7>)}. When such a trend of change in the distance is detected, the coordinate value calculation unit 110 calculates the coordinate values of the fall position of the gear tooth based on the position of the motor 37 at any time between the time when the distance d₂ was detected last time and the time the distance d₁ was detected for the first time. The coordinate values of the fall position can be calculated appropriately based on the position of the motor 37 at the concerned time and the speed reduction ratio of the power transmission member.

The methods for calculating the rise position and the fall position illustrated in FIGS. 4 and 5 are just a few examples. Thus, other known methods can be employed appropriately to calculate the rise position and the fall position.

The coordinate value calculation unit 110 executes the calculation of the coordinate values of the rise position and the fall position as exemplified above by a time allocated for each control cycle. In a case where the calculation of the coordinate values of one rise or fall position takes more time than specified, for example, the next fall position may pass the measuring position of the measuring instrument 35 while detecting the rise position of the gear tooth and calculating the coordinate of the rise position. Consequently, at the time that the coordinate value calculation unit 110 completes the calculation of the coordinate of the rise position, the distance data that records the fall position is lost from the buffer memory. In such a case, the coordinate values of the fall position cannot be calculated correctly. Thus, the measurement information recording unit 120 and the speed improperness determination unit 130 detect and notify a user about the occurrence of such a matter.

The measurement information recording unit 120 is configured to record measurement information about a time interval during which a geometry change occurs in a workpiece. The measurement information may be, for instance, a time interval, during which the geometry change occurs in the workpiece, calculated based on the signal input from the measuring instrument 35. In this case, the measurement information recording unit 120 may monitor the signal input from the measuring instrument 35, and determine that the detection of the occurrence of the geometry change only when the distance calculated based on the concerned signal changes by a predefined given distance dᵥ, which is over a predefined distance, within a predetermined time tᵥ. The measurement information recording unit 120 stores a time when the occurrence of the geometry change is detected in the RAM 13 or the non-volatile memory 14, for instance. Then, a difference between the time when the occurrence of the geometry change is detected and a time when the occurrence of the geometry change was detected one time before can be recorded as measurement information about the time interval during which the geometry change occurs. It is better to record only the shortest time interval in the measurement information about the time interval during which the geometry change occurs. In a case where the detected time interval during which the geometry change occurs is equal to or shorter than a predefined given time tₑᵣᵣ, the measurement information recording unit 120 may not take records for this time interval. This configuration enables handling of a case where the workpiece geometry change is erroneously detected due to disturbance, such as chattering.

The measurement information may be calculated based on the number of times of the geometry change occurrence in the workpiece within a predetermined time period. In this case, the measurement information recording unit 120 provides the RAM 13 or the non-volatile memory 14 with a counter for recording the number of times of the geometry change occurrence, for instance. Thus, the counter is increased each time it is determined that the geometry change is occurred during a predetermined time tₚ after the start of the measurement. Then, the predetermined time tₚ is divided by the value of the counter after a lapse of the predetermined time tₚ so as to record the value thus obtained as measurement information about the time interval during which the geometry change occurs. In a case where the time interval of the detected geometry change occurrence is equal to or shorter than the predefined given time tₑᵣᵣ, the measurement information recording unit 120 may not count the concerned geometry change. This configuration enables handling of the case where the workpiece geometry change is erroneously detected due to disturbance, such as chattering.

Furthermore, the measurement information may be calculated based on the specification of the workpiece geometry and the speed of the motor 37. The measurement information recording unit 120 acquires the speed of the motor 37 directly from the motor 37 or from a command speed for the motor 37. Then, the measurement information recording unit 120 calculates a time interval during which the geometry change occurs in the workpiece based on the speed of the motor 37 thus acquired, the speed reduction ratio of the power transmission member, and the specification of the workpiece geometry (e.g., in the case of the gear, root circumferential length, tooth tip circumferential length, root circle diameter, tooth tip circle diameter, number of teeth, tooth pressure, pitch circle), thereby recording the calculated value as measurement information.

The speed improperness determination unit 130 is configured to determine improperness of a relative speed between the workpiece and the measuring instrument based on the measurement information stored by the measurement information recording unit 120. For example, when the time interval during which the geometry change occurs in the workpiece is shorter than a preset given threshold tₜₕ, the speed improperness determination unit 130 may determine that the relative speed between the workpiece and the measuring instrument is improper. The given threshold tₜₕ may be calculated in advance by experiment, for instance. Furthermore, the predetermined time tₚ may be set in advance, or may be calculated based on a predefined given threshold cₜₕ and the speed of the motor 37. When the relative speed between the workpiece and the measuring instrument is determined to be improper, the speed improperness determination unit 130 notifies the coordinate value calculation unit 110 that the coordinate values have not been calculated correctly and thus the measurement object has not been evaluated correctly. Upon receipt of the notification, the coordinate value calculation unit 110 displays the calculated coordinate values on the display device 30 along with the notification that the coordinate values have not been calculated correctly and thus the measurement object has not been evaluated correctly. In addition, an alarm may be output at this time.

The measurement device 1 of the illustrative embodiment having the above-described configuration determines whether or not the coordinate values of the position where the geometry change occurs in the measuring surface of the measurement object can be calculated accurately, and when the calculation was not accurate, notifies a user about it. Upon receipt of the notification, the user can adjust the relative speed between the workpiece and a measurement device to measure the workpiece geometry again. Consequently, a correct result of workpiece measurement can be applied.

### Second Embodiment

Now, a description will be made about a measurement device according to a second embodiment of the present disclosure with reference to the accompanying drawings. A measurement device 1 according to the second embodiment has the same hardware configuration as that of the measurement device according to the first embodiment.

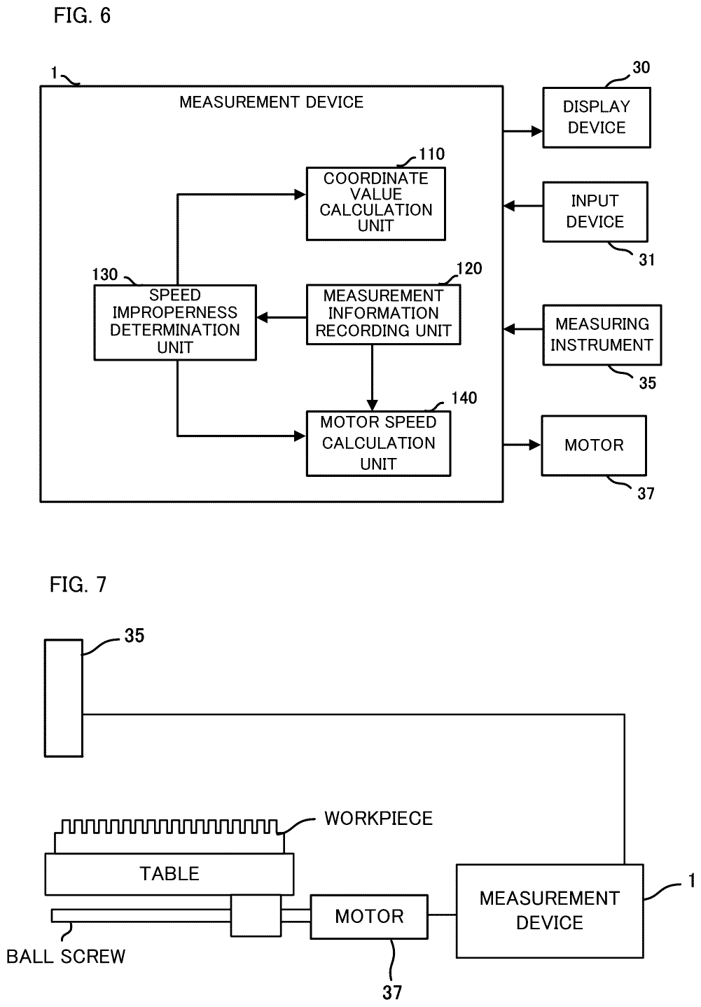

FIG. 6 shows functions of the measurement device 1 according to the illustrative embodiment in a schematic block diagram. The functions of the measurement device 1 of the illustrative embodiment are implemented in such a way that the CPU 11 included in the measurement device 1 shown in FIG. 1 executes a system program so as to control the operations of the components of the measurement device 1.

The measurement device 1 of the illustrative embodiment includes a motor speed calculation unit 140, in addition to the coordinate value calculation unit 110, the measurement information recording unit 120 and the speed improperness determination unit 130.

The coordinate value calculation unit 110 and the measurement information recording unit 120 of the illustrative embodiment have the same functions as those included in the measurement device 1 of the first embodiment.

The speed improperness determination unit 130 according to the illustrative embodiment issues a command to the motor speed calculation unit 140 to control the speed of the motor when it is determined that the relative speed between the workpiece and the measuring instrument is improper.

In response to the command to control the speed of the motor from the speed improperness determination unit 130, the motor speed calculation unit 140 acquires from the measurement information recording unit 120 the measurement information about the time interval during which the geometry change occurs. Then, the motor speed calculation unit 140 calculates a ratio of the acquired measurement information to the predefined given threshold tₜₕ. The motor speed calculation unit 140 in turn multiplies a speed of the motor 37 currently commanded by the calculated ratio, and set the obtained result as a new speed of the motor. At this time, the motor speed calculation unit 140 may also subtract a predefined given margin value Vm from the calculated speed of the motor. The motor speed calculation unit 140 may notify the user about the newly set speed of the motor 37 by displaying it on the display device 30, for example.

The measurement device 1 of the illustrative embodiment with the above-described configuration determines whether the coordinate values of the position where the workpiece geometry has changed can be calculated accurately, and when the calculation was not accurate, varies the speed of the motor based on the measurement information so that the coordinate values of the position where the workpiece geometry has changed can be calculated accurately. Consequently, a correct result of workpiece measurement can be applied.

The measurement device 1 according to the above-described embodiments determines whether or not the coordinate values of the position where the geometry of the measuring surface of the measurement object changes can be calculated accurately, and when the calculation was not accurate, notifies the user about it. Upon receipt of the notification, the user can adjust the relative speed between the workpiece and the measurement device to measure the workpiece geometry again. Consequently, the correct result of workpiece measurement can be applied.

The above-described embodiments show the examples of the measurement on the gear tooth geometry as the measuring object. However, as illustrated in FIG. 7, for instance, the measurement can be applied to the surface geometry of a workpiece other than the gear. FIG. 7 shows an example in which the measuring instrument 35 is placed over a measuring surface of a workpiece on a table. Then, the motor 37 is driven to move the table to allow the measuring instrument 35 to scan the surface of the workpiece along its surface. In such a case, the measurement device 1 of the present disclosure can also be used to determine whether or not the moving speed of the table is improper and notify the result to the user. The measurement device 1 of the present disclosure can be utilized effectively in the same way when the measuring instrument 35 is held by a robot or others to scan over the measuring surface of the workpiece.

The present disclosure has been described in detail as above, but is not limited to these embodiments. Thus, various additions, substitutions, modifications, partial deletions and so on may be made to these embodiments without departing from the gist of the disclosure or the spirit of the disclosure as derived from the contents described in the claims and their equivalents. Furthermore, these embodiments can be implemented by combining them. For example, the order of the operations and the order of the processes in these embodiments are provided by way of example, and thus are not limited thereto. Moreover, numeric values or formulars applied to these embodiments, if any, are also not limited thereto.

In regard to the above-described embodiments and their variations, supplementary notes will be disclosed as below.

### (Supplementary Note 1)

The measurement device includes a coordinate value calculation unit that shifts a relative position with respect to a measuring surface of a measurement object and, based on a signal input from the measuring instrument for measuring geometry change in the measuring surface, calculates coordinate values of a position at which the geometry of the measuring surface is changed, a measurement information recording unit that records measurement information about a time interval during which the geometry change occurs in the measuring surface of the measurement object, and a speed improperness determination unit that determines that the relative speed between the measuring surface of the measurement object and the measuring instrument is improper when the time interval during which the geometry change occurs in the measuring surface of the measurement object recorded by the measurement information recording unit is shorter than a predefined given first threshold. When it is determined that the relative speed between the measuring surface of the measurement object and the measuring instrument is improper, the speed improperness determination unit makes a notification that the measuring surface of the measurement object is not evaluated correctly.

### (Supplementary Note 2)

When the time interval during which the geometry change occurs in the measuring surface of the measurement object is shorter than a predefined given second threshold, the measurement information recording unit does not record the measurement information about the concerned time interval.

### (Supplementary Note 3)

The measurement device further includes a motor speed calculation unit that calculates a speed of a motor, which is not determined as improper, for relatively moving the measuring surface of the measurement object and the measuring instrument based on the measurement information and the first threshold when the speed improperness determination unit determines that the relative speed between the measuring surface of the measurement object and the measuring instrument is improper.

### (Supplementary Note 4)

The measurement device changes the above-described speed of the motor into the speed of the motor calculated by the motor speed calculation unit.

The measurement device according to claim 1, wherein when the speed improperness determination unit determines that the relative speed between the measuring surface of the measurement object and the measuring instrument is improper, a notification is made in the form of an alarm.

1. A measurement device, comprising:
a coordinate value calculation unit that moves a relative position with respect to a measuring surface of a measurement object, and calculates coordinate values of a position at which a geometry of the measuring surface is changed based on a signal input from a measuring instrument for measuring a geometry change in the measuring surface;
a measurement information recording unit that records measurement information about a time interval during which the geometry change occurs in the measuring surface of the measurement object; and
a speed improperness determination unit that determines that a relative speed between the measuring surface of the measurement object and the measuring instrument is improper when the time interval recorded by the measurement information recording unit, during which the geometry change occurs in the measuring surface of the measurement object, is shorter than a predefined given first threshold,
wherein when it is determined that the relative speed between the measuring surface of the measurement object and the measuring instrument is improper, the speed improperness determination unit makes a notification that the measuring surface of the measurement object is not evaluated correctly.

2. The measurement device according to claim 1, wherein when the time interval, during which the geometry change occurs in the measuring surface of the measurement object, is shorter than a predefined given second threshold, the measurement information recording unit does not record the measurement information about this time interval.

3. The measurement device according to claim 1, further comprises a motor speed calculation unit that calculates a speed of a motor, which is not determined as improper, for relatively moving the measuring surface of the measurement object and the measuring instrument based on the measurement information and the first threshold when the speed improperness determination unit determines that the relative speed between the measuring surface of the measurement object and the measuring instrument is improper.

4. The measurement device according to claim 3, wherein the speed of the motor is changed into a speed of the motor calculated by the motor speed calculation unit.

5. The measurement device according to claim 1, wherein when the speed improperness determination unit determines that the relative speed between the measuring surface of the measurement object and the measuring instrument is improper, a notification is made in the form of an alarm.
